(19) United States
(12) Patent Application Publication
(10) Pub. No.: US 2008/0011909 A1
(43) Pub. Date: Jan. 17, 2008

(54) Drinking straw holder

(76) Inventors: Enzo Daddario, Langley (CA); Jimmy Villarin, Surrey (CA)

Correspondence Address: GRAYBEAL, JACKSON, HALEY LLP, 155 - 108TH AVENUE NE, SUITE 350, BELLEVUE, WA, 98004-5973, US

(21) Appl. No.: 11/329,409

(22) Filed: Jan. 9, 2006

(51) Int. Cl. F16L 3/08

(52) U.S. Cl. 248/65

(57) ABSTRACT

A drinking straw holder is described for retaining a straw within a drinking container having a rim and an interior for holding a liquid. The holder comprises a body having a first retaining member adapted to fit over an edge of the drinking container and a second retaining member adapted to hold the straw within the interior of the drinking container. A display surface extends from the body for positioning external to the drinking container to display information or advertising material and the like. The holder is formed as a unitary, compact body that is ready to use without additional assembly or folding steps. The holder is easy to attach to the rim of a drinking container and allows for ready insertion of a drinking straw.

### FIELD OF THE INVENTION

This invention relates to a device for holding a drinking straw securely within a glass.

### BACKGROUND OF THE INVENTION

Devices for holding or retaining a drinking straw in a drinking container such as a glass or cup are well known. Probably the most common solution to this problem for soft drinks sold in disposable paper cups in convenience stores, concession stands or fast food restaurants is a plastic cover having a hole formed in the cover through which a straw is inserted and retained. Other examples of drinking straw holding devices are shown in the following references:

U.S. Pat. No. 5,823,493 to Eastland, Jr. et al.

U.S. Pat. No. 5,671,863 to Uliana

U.S. Pat. No. 5,109,995 to Lou

U.S. Pat. No. 5,046,628 to Florjancic

U.S. Pat. No. 4,775,060 to Pinney

### SUMMARY OF THE INVENTION

The present invention provides a drinking straw holder that uses preformed first and second retaining members to reliably hold a straw in place within any type of drinking container that includes an exposed rim. The holder is formed as a unitary, compact body that is ready to use without additional assembly or folding steps. The holder is easy to attach to the rim of a drinking container and allows for ready insertion of a drinking straw. The holder also provides a display surface for display of advertising or other information.

Accordingly, the present invention provides a drinking straw holder for retaining a straw within a drinking container having a rim and an interior for holding a liquid, the holder comprising:

a body having a first retaining member adapted to fit over an edge of the drinking container and a second retaining member adapted to hold the straw within the interior of the drinking container; and

a display surface extending from the body for positioning external to the drinking container.

### BRIEF DESCRIPTION OF THE DRAWINGS

Aspects of the present invention are illustrated, merely by way of example, in the accompanying drawings in which:

FIG. 1 is a perspective view of a drinking straw holder according to a preferred embodiment of the invention;

FIG. 2 is a side elevation view of the drinking straw holder of FIG. 1 installed on a drinking glass and supporting a straw;

FIG. 3 is a top plan view of the drinking straw holder of FIG. 1 installed on a drinking glass and supporting a straw;

FIG. 4 is front end elevation view of the drinking straw holder of FIG. 1; and

FIG. 5 is a rear end elevation view of the drinking straw holder of FIG. 1.

### DESCRIPTION OF THE PREFERRED EMBODIMENTS

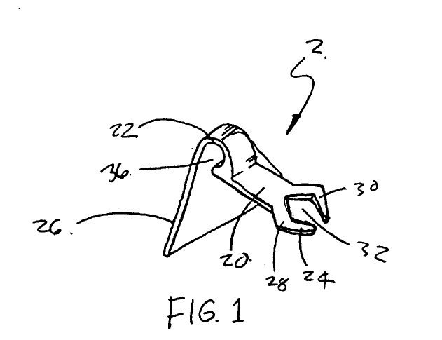

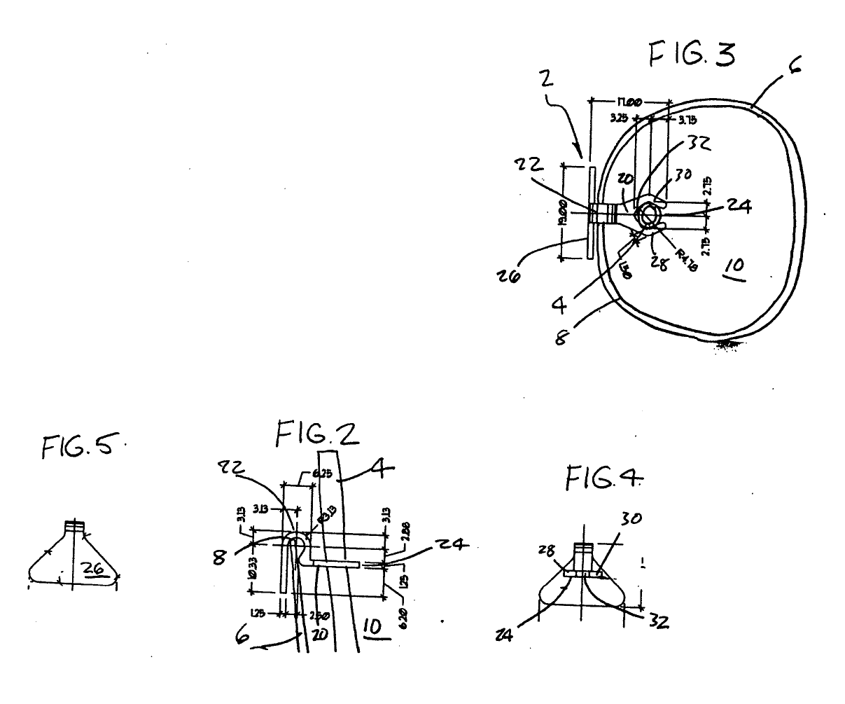

Referring to FIGS. 1 to 5, there is shown a preferred embodiment of the drinking straw holder 2 according to the present invention for retaining a straw 4 within a drinking container 6 having a rim 8 and an interior 10 for holding a liquid. The holder comprises a body 20 having a first retaining member 22 at one end of the body adapted to fit over rim 8 of drinking container 6 and a second retaining member 24 at the opposite end adapted to hold straw 4 within interior 10 of the drinking container. A display surface 26 also extends from body 20 for positioning external to the drinking container to display information such as advertising material or the like.

Second retaining member 24 is preferably formed as a straw retaining clip defined by a pair of arms 28 and 30. Arms 28 and 30 are generally arcuate and define a central opening 32 therebetween to releasably receive the straw. Preferably, arms 28 and 30 are flexible to accommodate insertion and removal of the straw.

First retaining member 22 is preferably formed as a rim retaining clip at an end of the body opposite second retaining member 24. First retaining member 22 and second retaining member 24 are also oriented at substantially right angles to each other in order to perform their rim holding and straw holding functions, respectively. In a preferred arrangement, the rim retaining clip comprises a hook 36 formed at the end of body 20 with a free end of the hook forming display surface 26. As best shown in FIG. 2, rim 8 of drinking container 6 is insertable into the slot created between the end of body 20 and the display surface 26 for secured attachment.

In the illustrated embodiment, display surface 26 is a generally triangular surface, however, any desired shape or dimensions for display surface 26 is possible.

Holder 2 is formed as a one piece body, preferably from a non-porous material such as plastic for hygienic reasons. The material is sufficiently rigid to be self-supporting while having some flexibility to permit resilient flexing of arms 28 and 30. It is contemplated that holder 2 will be disposed of after each use, however, it is possible that the holder can washed and reused.

Display surface 26 provides a prominent and easily readable surface for display of information including advertising such as a trademark logo. It can also be used as an identifying label to allow users to distinguish between drinks. As well as holding a straw in place in a drinking glass, the holder of the present invention is ideal as a promotional item in association with drinks purchased at a restaurant or other drinking establishment.

Although the present invention has been described in some detail by way of example for purposes of clarity and understanding, it will be apparent that certain changes and modifications may be practised within the scope of the appended claims.

I claim:

1. A drinking straw holder for retaining a straw within a drinking container having a rim and an interior for holding a liquid, the holder comprising:
a body having a first retaining member adapted to fit over an edge of the drinking container and a second retaining member adapted to hold the straw within the interior of the drinking container; and
a display surface extending from the body for positioning external to the drinking container to display advertising material.

2. The drinking straw holder of claim 1 in which the first retaining member and the second retaining member are oriented at substantially right angles to each other.

3. The drinking straw holder of claim 1 in which the second retaining member comprises a straw retaining clip defined by a pair of arms.

4. The drinking straw holder of claim 3 in which the arms are flexible.

5. The drinking straw holder of claim 3 in which the arms are generally arcuate and define an opening therebetween to releasably receive the straw.

6. The drinking straw holder of claim 1 in which the first retaining member comprises a rim retaining clip at an end of the body opposite the second retaining member.

7. The drinking straw holder of claim 6 in which the rim retaining clip comprises a hook formed in the end of the body with a free end of the hook forming the display surface.

8. The drinking straw holder of claim 1 in which the display surface comprises a generally triangular surface.
